(19) United States
(12) Patent Application Publication
(10) Pub. No.: US 2011/0288676 A1
(43) Pub. Date: Nov. 24, 2011

(54) METHOD AND DEVICE FOR THE SIMPLIFICATION OF MACHINE CONTROL PROCESS SEQUENCES

(76) Inventor: Guenther Landgraf, Karlstadt-Karlburg (DE)

(21) Appl. No.: 12/672,623

(22) PCT Filed: Aug. 14, 2008
(86) PCT No.: PCT/EP2008/006689

§ 371 Date: Feb. 8, 2010

(30) Foreign Application Priority Data
Aug. 17, 2007 (DE) 10 2007 039 020.5

(51) Int. Cl. G05B 19/18

(52) U.S. Cl. 700/173

(57) ABSTRACT

The invention relates to a method for the simplification of process sequences and the control of a machine, and particularly of a machining tool, wherein the tool has a plurality of sub-systems, and each individual sub-system of the tool operates with process sequences having clock conditions that differ at least partially. According to the invention, data sets are collected by means of a data collection device, said sets characterising the clock conditions of the individual clock systems, and at least two data sets are output to the user at least in a partially mutual manner by means of a display device.

The present invention relates to a method and a device for the simplification of machine control process sequences. The method and the device are described with reference to a machining tool that is used to machine bodies. However, it is pointed out that the method according to the present invention and the device according to the present invention may also be used on other machines.

In modern machining tools, it is common for several subsystems of the machine, e.g., a robot, which move or machine a work piece in a certain manner to be controlled by different controllers or different process sequences. Care is taken to ensure that individual subsystems cooperate with one another in the desired manner, thereby making it possible, e.g., to manufacture a work piece that has been machined in a certain manner.

The individual subsystems operate under different cycle conditions, however, and the problem therefore occurs that, e.g., individual subsystems require more time to perform a certain operation than would be necessary in and of itself.

In cases such as these, it is very difficult for the user to determine which of the subsystems of a machine of this type are unnecessarily wasting resources, e.g., taking an unnecessarily long period of time to perform a certain machining operation.

The object of the present invention, therefore, is to provide a method and a device that make it possible to monitor a total system in terms of the individual process sequences of this total system. This object is attained according to the present invention by using a method as recited in claim 1, and a device as recited in claim 12. Advantageous embodiments and developments are the subject matter of the dependent claims.

In a method, according to the present invention, for the simplification of machine control process sequences for the control of a machine, and, in particular, of a machining tool, the machine includes a large number of subsystems, and each of the individual subsystems of the machine operates using process sequences having cycle conditions that differ at least partially. According to the present invention, data sets that are characteristic of the cycle conditions of the individual subsystems are collected via a data collection device, and at least two data sets of this type are made available, in an at least partially combined manner, to the user, in particular via a display device.

Subsystems of the machine may be, e.g., individual motors (digital intelligent drives) or individual devices that perform a certain part of an entire operation, such as drills, sanding machines, milling machines, and the like. The subsystems may also be sensor-controlled systems or sensor devices.

“Data sets” are understood to be data sets that describe a certain process sequence of a particular subsystem, such as the motion of a spindle. “Data” and “data sets” are therefore also intended to mean measured signals or the values measured via signal measurement. The data collection device is, in particular but not exclusively, a memory unit in the form, e.g., of a volatile memory unit or a permanent memory into which the individual data sets may be input so that they may be subsequently visualized to the user.

It is therefore possible to collect and display the data in various time domains and, in particular, in a cycle-synchronous manner. In all, it is therefore made possible to display the individual data of the various subsystems in a higher-order manner in order to analyze cycle time.

The data are preferably displayed in corresponding time periods, which may be accomplished via the use of time stamps.

In contrast to known analyzers which are tailored to the special needs of the individual time systems, a higher-order means is therefore made available which depicts the data from the various subsystems together in one display.

Therefore, according to the present invention, depictions are therefore also made available that show all of the time delays that are involved under certain circumstances (in process sequences, signals, and/or data from the various subsystems) together in one display. In this manner, depictions and functions are obtained that provide the user with an overview of a particular issue as quickly as possible, thereby making it possible for him to rectify a certain problem as quickly as possible, if necessary. Specifically, the user is provided with the capability to quickly analyze machine cycle times.

The two data sets are preferably assigned to at least two different subsystems. It is possible, for instance, to show the data sets from a first machining unit and a second machining unit together in the same display, in order to thereby permit the user to decide which of the fundamental process sequences may possibly be shortened.

Advantageously, the at least two data sets are assigned to different process sequences of the same subsystem. For any given subsystem, it is therefore possible, e.g., that an older process sequence exists, as well as a process sequence that was programmed at a later date and is therefore more recent. These two process sequences may be compared in terms of their cycle conditions and, in particular, in terms of their cycle times, in which case it is preferable to exactly determine in which parts of the particular process sequences the cycle times, for instance, of the two data sets differ. It is therefore possible to perform a combined analysis of different process sequences of the same subsystem, and to make targeted improvements to process sequences.

The cycle conditions are preferably cycle times of the individual subsystems. However, “cycle conditions” may also refer to other conditions, such as the use of available memory, and the like. Finally, an analysis of the individual cycle times is of particular importance since it permits the lengths of time required for individual process sequences to be analyzed and shortened, thereby making it possible to design the processing work performed by the particular machines to take place more quickly.

The data sets of all subsystems are preferably output to the user in a combined manner. The user is therefore provided with a global overview of all subsystems, thereby giving him the option to optimize individual subsystems relative to the overall process. The data sets may be data sets for the particular complete process sequences, although parts of these data sets could also be analyzed separately in order to thereby save time resources.

In a further advantageous embodiment, the data collection device also collects time stamps of the processes taking place in the individual machines. By using these time stamps, processes in different time domains or processes that take place in the same instants may be compared directly to one another. These time stamps are preferably collected via master programs that assign subprocesses to certain instants or periods in which these subprocesses take place. The individual time stamps are preferably generated via a time generator.

Preferably, for each subsystem, a large number of time intervals is defined for different process sequences that take place in the subsystem. If the subsystem is a drill, for instance, the processes that involve this drill may be subdivided into the drilling procedure itself (main time), a tool change procedure to replace a tool (tool change time), and the approach and withdrawal motions (secondary time), during which drilling is not performed, but the boring spindle is moved into a setpoint position, and the like.

The time intervals are preferably selected from a group of time intervals that includes main times, secondary times, tool change times, work piece change times, measurement times, loading times, unloading times, combinations thereof, and the like.

Particularly preferably, the time intervals of different subsystems are compared to one another. In this manner, a check may be carried out to determine, e.g., whether another tool is at rest during a secondary time of a certain tool, or whether this time could be used to perform a machining operation using the other tool.

The data sets are preferably used to determine process times of parts of process sequences and, on the basis of these process times, information and, in particular, recommendations and/or handling instructions are output to the user. It is also possible for changes to be carried out in an automated manner on the basis of process times (possibly with additional information being requested of the user).

It is possible, e.g., for the method according to the present invention to be used to identify an excessively long process time for a certain tool, and for the system to therefore prompt the user to check the particular process time and to optimize it, possibly by restructuring program sequences in a suitable manner. Preferably, proposals for optimizing the cycle time are generated.

The data sets that are determined and/or collected are preferably made available via the Internet and/or an intranet. A method is therefore proposed in which it is possible to determine, evaluate, and display data sets independently of one another in terms of location. The collected data sets may also be evaluated via the Internet.

Advantageously, a least a portion of the data or data sets to be collected are measured via a control device for the machine. For example, current values may be read out via the control device.

The present invention is furthermore directed to a device for the simplification of process sequences for the control of a machine, and, in particular, of a machining tool, in which the machine includes a large number of subsystems, and each of the individual subsystems of the machine operates using process sequences having cycle conditions that differ at least partially. According to the present invention, the device includes a data collection device that collects data sets that are characteristic of the cycle conditions for the individual subsystems, and at least one display device that outputs at least two data sets in an at least partially combined manner.

“Subsystems” that operate under cycle conditions that differ from one another at least partially are understood to mean that not all subsystems operate under identical cycle conditions and, in particular, identical cycle times.

Advantageously, the device includes a comparator unit that compares at least two data sets to one another and outputs a signals that is characteristic of this comparison, or it displays a table or a graphical representation. The device preferably also includes a time generator that generates time stamps that are recorded by the data collection device.

Further advantages and embodiments result from the attached drawings:

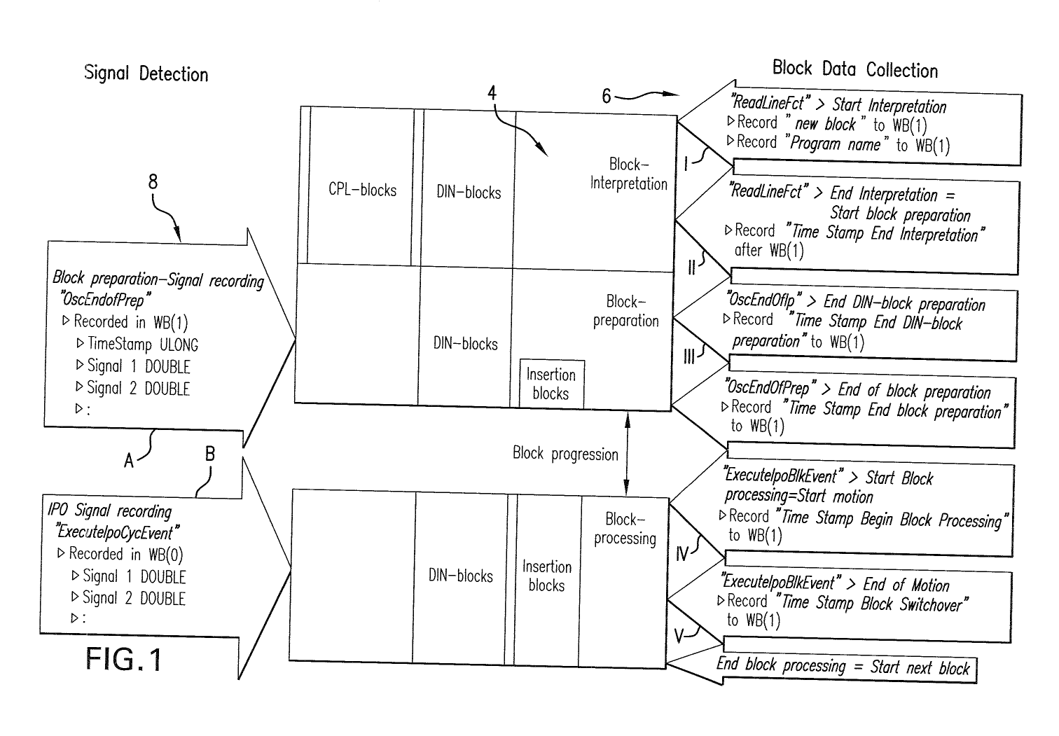

FIG. 1 shows a block diagram which illustrates a substep for collecting data;

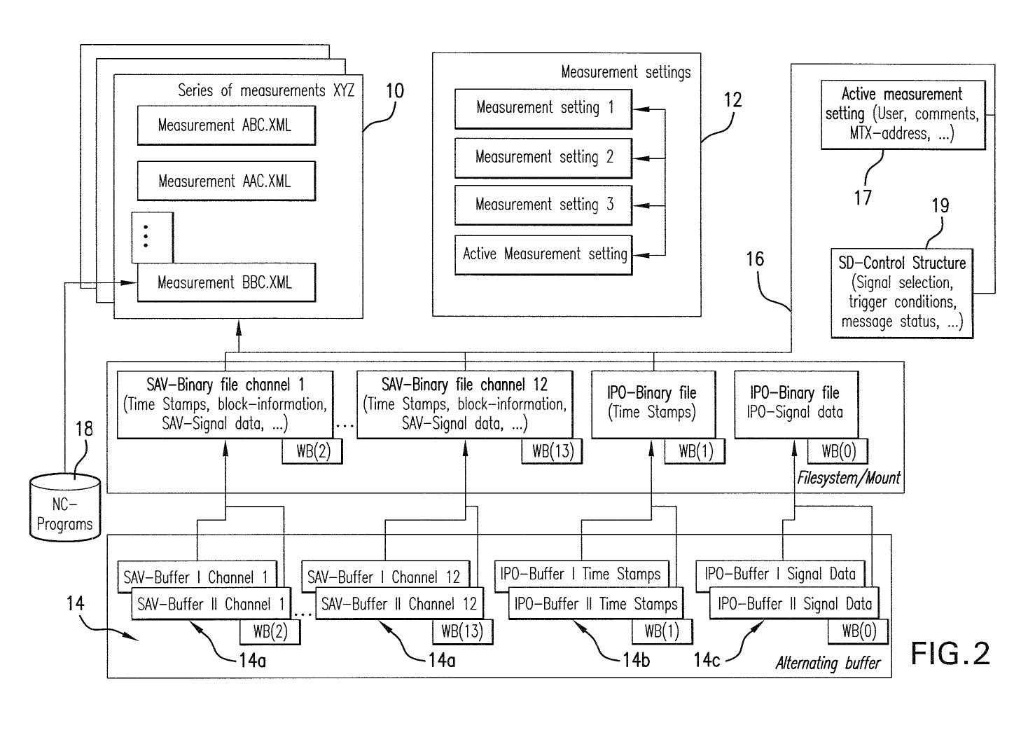

FIG. 2 shows a block diagram which illustrates a further substep for collecting data;

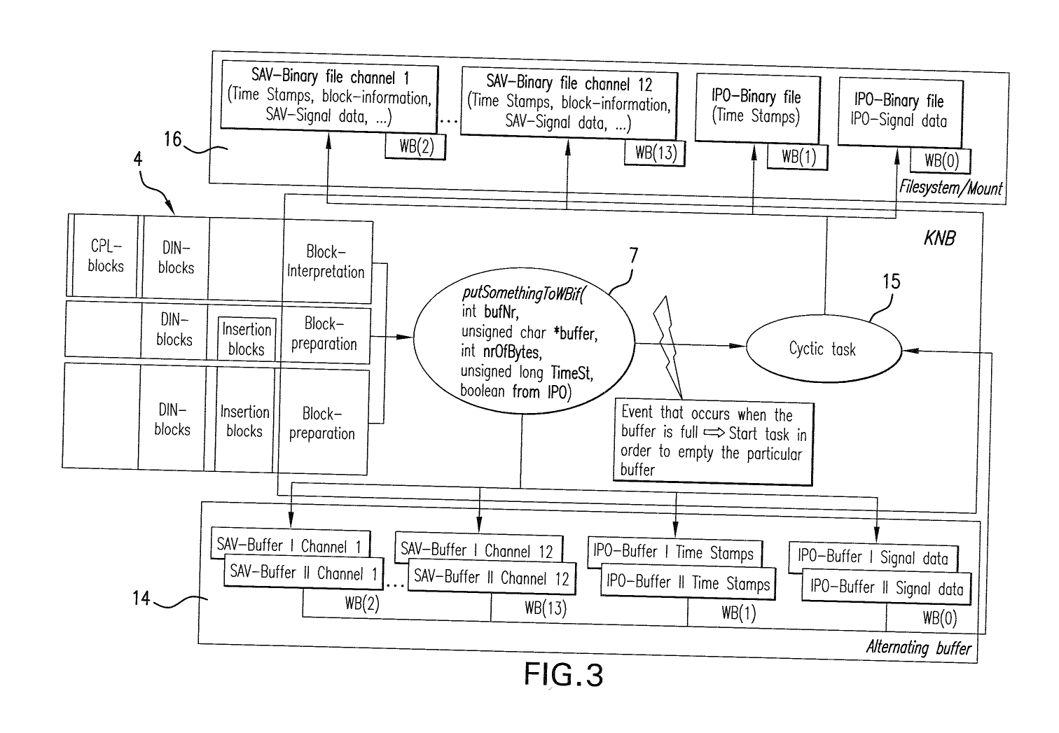

FIG. 3 shows an overall view in the form of a block diagram which illustrates the data collection process;

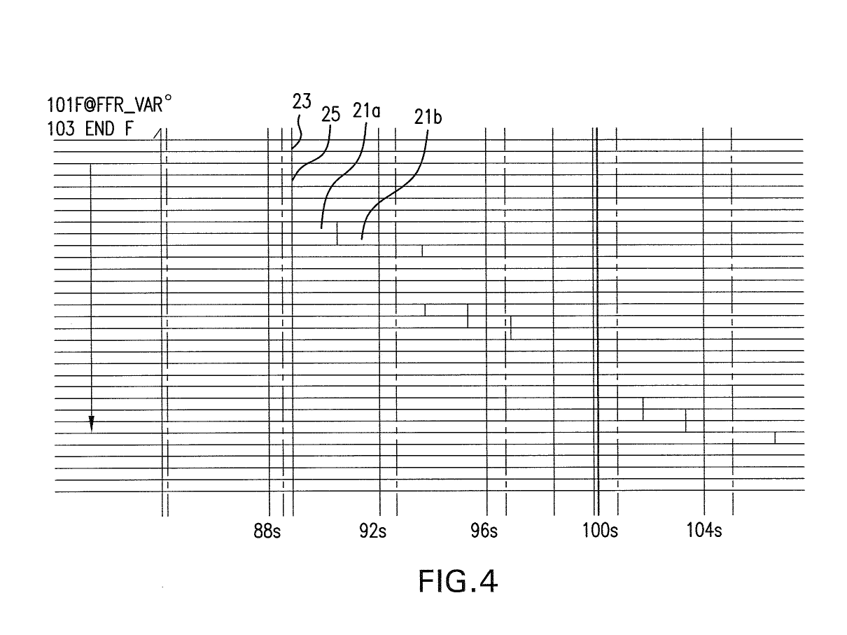

FIG. 4 shows a visualization of data that are output via a display device;

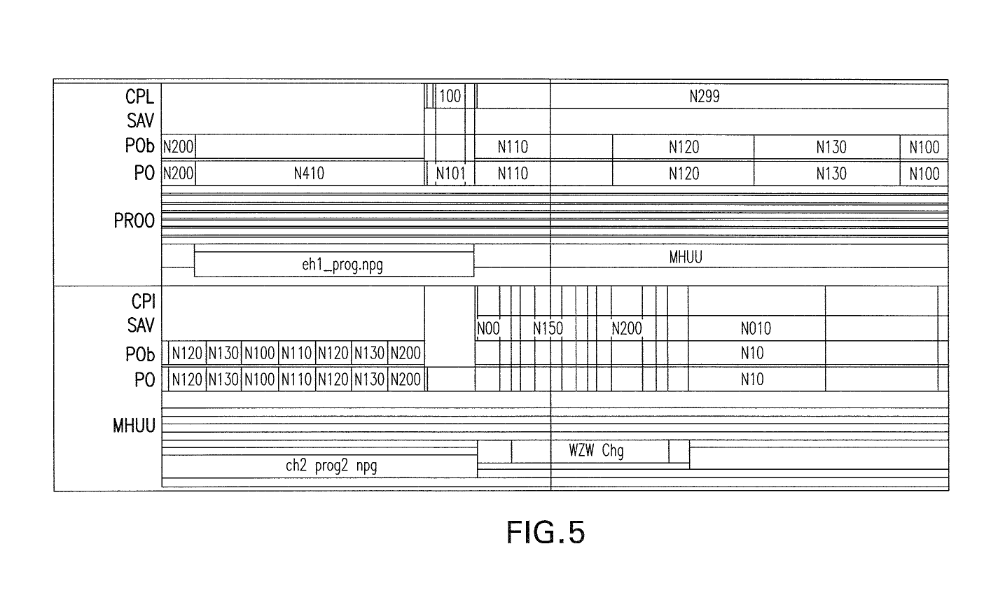

FIG. 5 shows a further visualization of data that are output via a display device;

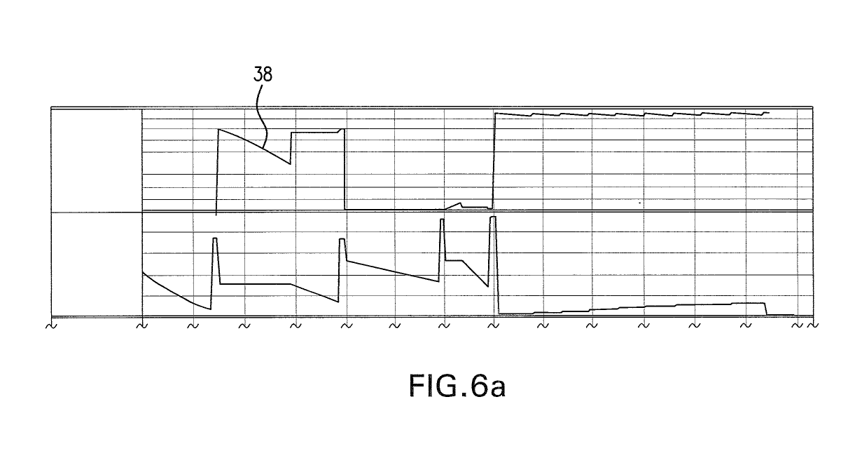

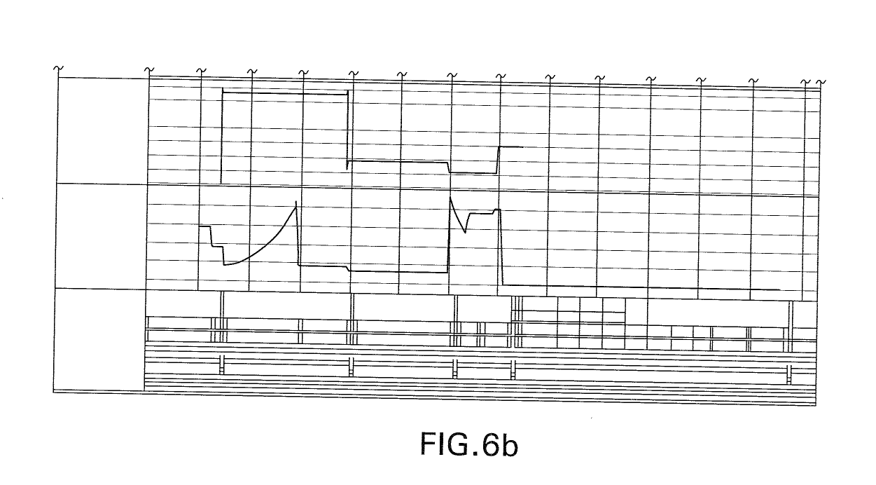

FIGS. 6a, b show further depictions that illustrate the display of data; and

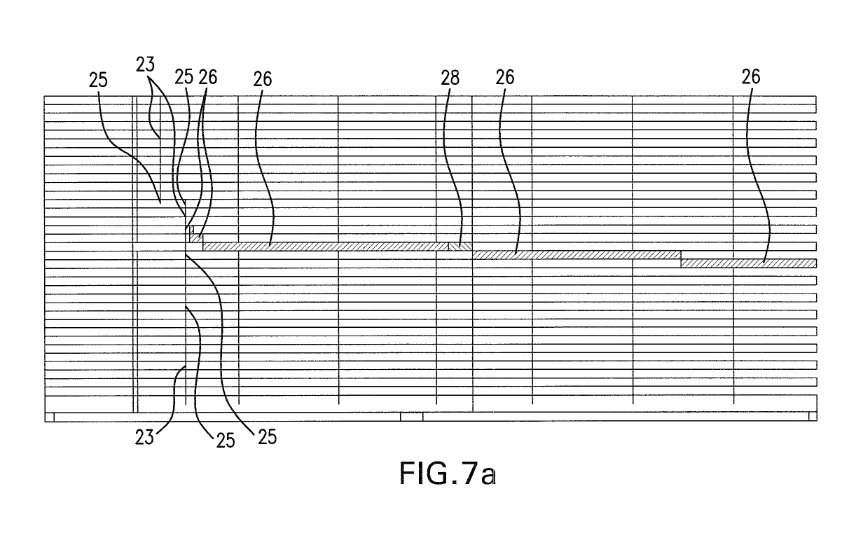

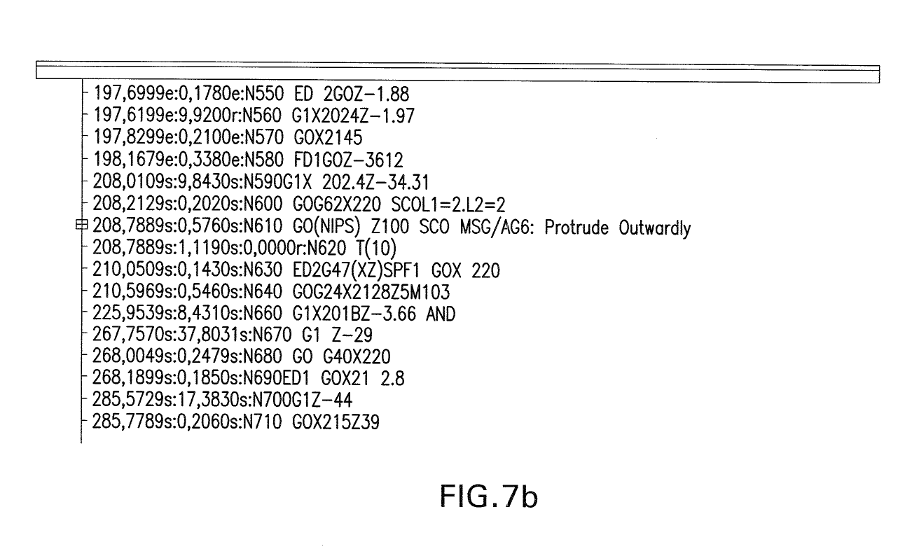

FIGS. 7a, b show further depictions that illustrate the display of data.

FIG. 1 shows a block diagram which illustrates a subprocess of data collection. Reference numeral 4 refers to a data collection device or a unit of this data collection device. Data collection device 4 gathers block data 6 and signals 8. Within the scope of block data collection, program instructions may be read in, for instance.

Uppermost arrow I indicates, e.g., the start of an interpretation, in which case a new block and its program name are read into and/or are recorded by a memory WB (1). During this recording process, a time stamp that indicates the start of the interpretation is also recorded, as are the individual row numbers of the sets in the particular program to be read in. In addition, a unique ID (or address) for assigning subsequent time stamps is also recorded, as well as a name of the program or subprogram (UP). Finally, the actual depth of the subprogram affected is also recorded.

Using the unique ID and the time stamp, signal data and block data may be subsequently combined for display purposes.

In recording the program name, one name of a specific length may be recorded for the program.

In a further step II, the end of the particular interpretation, which simultaneously marks the start of block preparation, is input. In this case as well, a time stamp is input, as well as a unique address for assigning time stamps.

In a similar manner, time stamps (step III) that mark the end of block preparation (SAV) are input, as are corresponding unique addresses for assigning these time stamps. Furthermore, as shown in the lower section of block processing, time stamps are also recorded that record the start of block processing and/or the start of a certain motion (step IV), as well as a time stamp. These data are recorded in memory unit WB (1). Finally, the program part is recorded that marks the end of block processing (step V), and a time stamp for the block switchover is also input. When block processing has been completed, a new block may be processed if all necessary conditions are met, e.g., “specified spindle rotating speed has been reached” and, on the basis thereon, the block progresses via block preparation. Parallel to the block processing, the controller (e.g., subsystem=NC channel 1) inputs further NC blocks, interprets them, and prepares them accordingly for use in processing the blocks.

Parallel to block interpretation, preparation, and processing, individual signals (which may be defined by the user) are detected. The signals may be signals, e.g., that are characteristic of a certain position of a certain machine or a certain rotational speed or voltage or the like (e.g., the specified setpoint positions in the work piece coordinate system). These signals may be input in the form of values. These signals are also read into the buffer unit (WB) (1) (step A). Further, corresponding signals, e.g., for further machines or subsystems, may be input into memory units WB(2)-WB(13). However, it should be pointed out that more or fewer memory units of this type may also be provided at this point. Time stamps are also input together with the signals in this case. Via these time stamps, it is possible to locate the particular corresponding block data.

IPO signals are also recorded. IPO signals are signals that may be transmitted, e.g., to a PLC and output instructions there. In the method depicted in FIG. 1, these signals are input into the memory unit WB(0). These signals may be, e.g., a large number of values, each of which is input. Time stamps, which may also include an associated ID, are also input when the IPO signals are recorded.

Unit 4 of the collection device therefore contains different data in the region of block interpretation, block preparation, and block processing. In the region of block preparation and block processing, insertion blocks are also input. In the region of block interpretation, CPL records (a high-level language similar to Basic) are also input.

FIG. 2 shows a further depiction of the inputting of individual data. Series of measurements XYZ and measurement settings are stored in memory units 10 and 12. The individual subsystems of the overall device are controlled on the basis of the measurement settings. The results that are recorded are stored within the series of measurements, and will be subsequently depicted graphically in highly diverse manners. Reference numeral 14 indicates an interchangeable memory unit, into which the individual block and signal data were input, as will be explained in greater detail below. In the embodiment shown in FIG. 2, 12 NC channels 14a are provided for storing the above-mentioned block data for block preparation and signal recording, as well as a further memory block 14b for recording the time stamps which mark, e.g., the start of block preparation, that is, the start of the motion and the end of the motion. A further memory block 14c gathers the (IPO) signal data. Individual block memories WB(2)-WB(13) and WB(1) and WB(0) are each designed as two-staged memories. Entire interchangeable memory system 14 is a volatile memory system which may, in turn, load its data contents into permanent memories 16 (file system/mount).

The data that are loaded into file system 16 are ultimately used as the basis for the display which is explained in detail below. Furthermore, as shown in FIG. 2, the data that are stored in file system 16 are transferred, e.g., to a measurement “BBL.XML”. That is, the binary data that were collected are transferred to a more easily readable XML structure and are supplemented with additional data, which are required for the subsequent visualization, such as associated NC programs 18, comments 17 entered by the user, or the measurement setting entered by the user via the use of a data structure 19 (selected signals, selected signal or block trigger condition, status of the measurement, . . . ) 12.

FIG. 3 shows an overall view, in the form of a block diagram, of the process of collecting data sets. Reference numeral 4 indicates the unit of the data collection device which is also shown in FIG. 1. The individual data that are input in unit 4 are transferred to a data distribution device 7 and, from this, into above-mentioned alternating buffer 14. From alternating buffer 14, the data sets are transferred to a cyclic data distribution device 15 and, from there, to above-mentioned permanent memory system 16. The transfer of data to memory system 16 may be started, e.g., when individual buffer memories of buffer memory unit 14 become full. In this case, the related buffer may be emptied, or it may be simply overwritten via the use of additional codes.

The individual data sets may be displayed, as described below, on the basis of the data stored in memory unit 16.

Specifically, the corresponding data make it possible to provide a first overview of the machine, thereby making it possible to determine what times are required for which subsequences or on which subsystems. For example, the individual process times, such as main times, secondary times, tool change times, pallet times. and user times for the desired channels and tools and the like may be depicted graphically.

In addition, a highly detailed depiction and analysis of the individual process sequences in the various subsystems may be carried out on the basis of the available, more extensive data basis (in the extreme case, up to several gigabytes of data may be recorded for a measurement, depending on the file system that is present).

FIG. 4 shows an example of a depiction that was output and may be used to perform an analysis or block analysis of an NC program. Individual bars 21a, 21b describe a motion of a certain element or machine part; the length of these bars is a measure of the motion times of the individual elements. Within the scope of the depiction shown in FIG. 4, continual motions are shown, and so individual bars 21a, 21b adjoin one another directly along the time axis. The blocks of a related instruction program are shown in the left-hand column of FIG. 4. Reference numeral 23 refers to the time period for the interpretation of a certain record, and reference numeral 25 indicates the preparation of a certain motion. These periods are very short as compared to the periods used for the motion, and so the corresponding periods of time are shown merely as vertical lines in this solution. The particular times that may be determined via the time stamps that were also recorded were plotted on the y-axis.

It is clear that the particular block interpretation (CPL) and preparation (NC) are both located ahead—in terms of time—of the actual motion (IPO) or execution (IPO). Furthermore, the depiction shown in FIG. 4 also visualizes the interplay of the individual subprocesses with one another. In this manner, interruptions and delays in the motion may be detected on the interpolator (IPO) in a targeted manner as gaps in the block execution, and measures may be derived therefrom as necessary.

A multiple-channel block analysis of the data sets may also be carried out; this multiple-channel block analysis is also available, in particular, for data set analysis that is carried out across channels. Information that is similar to the depiction shown in FIG. 3 is delivered, although the block analysis is carried out for a plurality of channels in this case. The block progression, i.e., the individual program numbers in particular, are also plotted horizontally in this case, i.e., on the time axis. The motions of two different systems, for instance, may thereby be compared in particularly clear manner. An example of a depiction of this type is shown in FIG. 5.

The process of collecting data, according to the present invention, also makes it possible to provide the user with a quick overview of the various execution times, e.g., the particular program sequences, and the NC and CPL blocks that were processed. It is therefore possible to output the time required, e.g., for every individual row of a program that was processed. The depiction may be designed as a list of rows, in which case a time that is required to process these rows may be indicated for every individual program row. It would also be possible to output the times required to process certain groups of rows.

In a further depiction, it is possible to display the data in the form of a table, thereby making it possible, in particular, to investigate the deviations of a plurality of runs of an NC program in greater detail. By using a table of this type, it would also be possible to indicate minimum times, maximum times, time differences, mean times, and the like.

It is possible, for example, to execute a certain process sequence using different programs, and to subsequently check the deviations in individual steps. The particular NC or CPL block may be entered in a column of this type, in a table of this type, and, in a further column, to enter the time required (either the block interpretation time, the block preparation time, the block processing time, the motion execution time, or the program execution time) for the applicable NC/CPL block; further columns may contain information on the programmed tool, e.g., a rotational speed, a programmed F value, the type of processing time, i.e., whether it is a main time or a secondary time, a mean time, a minimum time, a maximum time, a time difference, and the like.

Using a depiction of this type, fluctuations that may indicate the presence of errors, and, in particular, hardware or software errors, may be detected in particular. Specifically, it may be determined whether individual NC/CPL blocks, or the subsequences they trigger, e.g., the acceleration of a tool spindle to a specified rotational speed via the PLC take a particularly long time, which could indicate the presence of an error.

The related depiction may also be output in a table that compares two different program states. Via a table-based comparison, it is possible to investigate two program states exactly in terms of their deviations from one another, or their differences from one another. A table-based comparison of this type may be used to provide the user with information, e.g., the program name, the NC/CPL block, and the time differences. Differences between programs and their effects on the cycle time may be investigated very quickly in this manner. This approach also makes it possible to quickly eliminate program parts that take up an unnecessarily long period of time.

An example of a depiction of this type is shown in table 1, below:

TABLE 1

| C:\...\Daten\Seicas1msZek Bearbeitung 468_716s recdat.xml | | | | | C:\...\Daten\|Sercos 4ms Zeit Bearbeitung 481_548 recdat.xml | | | |
|---|---|---|---|---|---|---|---|---|
| Line | Program | NC block | Time | | Time | NC block | Program | Line |
| 19 | Prog.OP10.npg | 20 WAIT | 0.0370 | > | 0.0360 | 20 WAIT | Prog.OP10.npg | 19 |
| 20 | Prog.OP10.npg | 30 START TIME % = CLOCK | ~0 | = | ~0 | 30 START TIME % = CLOCK | Prog.OP10.npg | 20 |
| 1 | T | 001 DIM ANGLETXT$(24) | ~0 | = | ~0 | 001 DIM ANGLETXT$(24) | T | 1 |
| 2 | T | 010 CHANNEL % = SD(8) | ~0 | = | ~0 | 010 CHANNEL % = SD(8) | T | 2 |
| 3 | T | 011 TNR % = P1% | ~0 | = | ~0 | 011 TNR % = P1% | T | 3 |
| 4 | T | 012 #REVTURN % = 1 | ~0 | = | ~0 | 012 #REVTURN % = 1 | T | 4 |
| 6 | T | 015 IF P2$ = NUL THEN ANGLE = | ~0 | = | ~0 | 015 IF P2$ = NUL THEN ANGLE = | T | 5 |
| | | 999.999 ELSE | | | | 999.999 ELSE | | |
| 9 | T | 021 ENDIF | ~0 | = | ~0 | 021 ENDIF | T | 9 |
| 10 | T | 052 CASE CHANNEL % OF | ~0 | = | ~0 | 052 CASE CHANNEL % OF | T | 10 |
| 11 | T | 054 LABEL 1: | ~0 | = | ~0 | 054 LABEL 1: | T | 11 |
| 3 | TL | 20 PRETOOLNR % - P1%: REM | ~0 | = | ~0 | 20 PRETOOLNR % - P1%: REM | TL | 3 |
| | | Tool number preselected tool | | | | Tool number preselected tool | | |
| 4 | TL | 20 ANGLE = P2: REM ANGLE | ~0 | = | ~0 | 20 ANGLE = P2: REM ANGLE | TL | 4 |
| | | FOR ANGLE BORING HEAD | | | | FOR ANGLE BORING HEAD | | |
| 5 | TL | 20 #NEXTOOL % = | ~0 | = | ~0 | 20 #NEXTOOL % = | TL | 5 |
| | | PRETOOLNR %: REM Tool | | | | PRETOOLNR %: REM Tool | | |
| | | number preselected tool | | | | number preselected tool | | |
| 7 | TL | 22 #WEARUNIT % = 100: REM | ~0 | = | ~0 | 22 #WEARUNIT % = 100: REM | TL | 7 |
| | | Wear unit 1 = cycles/0 = seconds | | | | Wear unit 1 = cycles/0 = seconds | | |
| 8 | TL | 23 #MAXEDGE % = 3: REM | ~0 | = | ~0 | 23 #MAXEDGE % = 3: REM | TL | 8 |
| | | Maximum number of cuts per tool | | | | Maximum number of cuts per tool | | |
| 10 | TL | 25 #WZERR % = 0: REM | ~0 | = | ~0 | 25 #WZERR % = 0: REM | TL | 10 |
| | | Variable for tool error handling | | | | Variable for tool error handling | | |
| 11 | TL | 30 #WZWARN % = 0: REM | ~0 | = | ~0 | 30 #WZWARN % = 0: REM | TL | 11 |
| | | Variable for tool warnings | | | | Variable for tool warnings | | |
| 12 | TL | 35 #RECFOUND % = 0: REM | ~0 | = | ~0 | 35 #RECFOUND % = 0: REM | TL | 12 |
| | | Data block 1 = found/0 = not found | | | | Data block 1 = found/0 = not found | | |
| 13 | TL | 40 #WZINTERN % = 0: REM | ~0 | = | ~0 | 40 #WZINTERN % = 0: REM | TL | 13 |
| | | Store DBTAB, DBSEA errors | | | | Store DBTAB, DBSEA errors | | |
| 14 | TL | 42 OLDTOOLNR % = 0: REM | ~0 | = | ~0 | 42 OLDTOOLNR % = 0: REM | TL | 14 |
| | | Number of the tool that was | | | | Number of the tool that was | | |
| | | replaced | | | | replaced | | |
| 15 | TL | 43 OLDDUPLONR % = 0: REM | ~0 | = | ~0 | 43 OLDDUPLONR % = 0: REM | TL | 15 |
| | | Duplo-number of the tool that was | | | | Duplo-number of the tool that was | | |
| | | replaced | | | | replaced | | |
| 16 | TL | 44 OLDSEKTOR % = 0: REM | ~0 | = | ~0 | 44 OLDSEKTOR % = 0: REM | TL | 16 |
| | | Number of the tool that was | | | | Number of the tool that was | | |
| | | replaced | | | | replaced | | |
| 17 | TL | 45 OLDPLACE % = 0: REM | ~0 | = | ~0 | 45 OLDPLACE % = 0: REM | TL | 17 |
| | | Duplo-number of the tool that was | | | | Duplo-number of the tool that was | | |
| | | replaced | | | | replaced | | |
| 18 | TL | 46 PRESEKTOR % = 0: REM | ~0 | = | ~0 | 46 PRESEKTOR % = 0: REM | TL | 18 |
| | | Sector of the preselected tool | | | | Sector of the preselected tool | | |
| 19 | TL | 47 PREPLACE % = 0: REM | ~0 | = | ~0 | 47 PREPLACE % = 0: REM | TL | 19 |
| | | Place of the preselected tool | | | | Place of the preselected tool | | |
| 21 | TL | 50 DIM TOOLSTATUS$(3,20): | ~0 | = | ~0 | 50 DIM TOOLSTATUS$(3,20): | TL | 21 |
| | | REM tool status BQ2 | | | | REM tool status BQ2 | | |
| 22 | TL | 55 DIM DBVALUE$(40): REM | ~0 | = | ~0 | 55 DIM DBVALUE$(40): REM | TL | 22 |
| | | Value of the DB element | | | | Value of the DB element | | |
| | | searched for | | | | searched for | | |
| 23 | TL | 60 DIM SEARCHCOND$(100): | ~0 | = | ~0 | 60 DIM SEARCHCOND$(100): | TL | 23 |
| | | REM String for search conditions | | | | REM String for search conditions | | |
| 24 | TL | 65 DIM WZERR$(200): REM | ~0 | = | ~0 | 65 DIM WZERR$(200): REM | TL | 24 |
| | | Error message text | | | | Error message text | | |
| 25 | TL | 67 DIM WZWARN$(200): REM | ~0 | = | ~0 | 67 DIM WZWARN$(200): REM | TL | 25 |
| | | Warning message text | | | | Warning message text | | |
| 26 | TL | 68 DIM KANAL$(10): REM | ~0 | = | ~0 | 68 DIM KANAL$(10): REM | TL | 26 |
| | | Channel string for errors and | | | | Channel string for errors and | | |
| | | warnings | | | | warnings | | |
| 27 | TL | 68 KANAL$ = “Channel1:” | ~0 | = | ~0 | 68 KANAL$ = “Channel1:” | TL | 27 |
| 30 | TL | 70 IF PRETOOLNR % < 0 THEN | ~0 | = | ~0 | 70 IF PRETOOLNR % < 0 THEN | TL | 30 |
| 33 | TL | 80 ELSE | ~0 | = | ~0 | 80 ELSE | TL | 33 |
| 34 | TL | 85 IF PRETOOLNR % = 0 THEN | ~0 | = | ~0 | 85 IF PRETOOLNR % = 0 THEN | TL | 34 |
| 36 | TL | 95 ENDIF | ~0 | = | ~0 | 95 ENDIF | TL | 36 |
| 37 | TL | 100 ENDIF | ~0 | = | ~0 | 100 ENDIF | TL | 37 |
| 43 | TL | 101 SV.K1ToolPre.Hd = | ~0 | = | ~0 | 101 SV.K1ToolPre.Hd = | TL | 43 |
| | | DBSEA(“DBT1”, −1, −1, | | | | DBSEA(“DBT1”, −1, −1, | | |
| | | “BQ2 = 1:1, K1 = 1”, #RECFOUND | | | | “BQ2 = 1:1, K1 = 1”, #RECFOUND | | |
| | | %, #WZERR %) | | | | %, #WZERR %) | | |
| 44 | TL | 102 IF (#WZERR % <> 0) THEN | ~0 | = | ~0 | 102 IF (#WZERR % <> 0) THEN | TL | 44 |
| 48 | TL | 106 ELSE | ~0 | = | ~0 | 106 ELSE | TL | 48 |
| 49 | TL | 107 IF #RECFOUND % = 0 THEN | ~0 | = | ~0 | 107 IF #RECFOUND % = 0 THEN | TL | 49 |
| 51 | TL | 109 ENDIF | ~0 | = | ~0 | 109 ENDIF | TL | 51 |
| 52 | TL | 110 ENDIF | ~0 | = | ~0 | 110 ENDIF | TL | 52 |
| 54 | TL | 125 IF #WZERR % = 115 THEN | ~0 | = | ~0 | 125 IF #WZERR % = 115 THEN | TL | 54 |
| 61 | TL | 150 ELSE | ~0 | = | ~0 | 150 ELSE | TL | 61 |
| 63 | TL | 152 SV.K1ToolAct = | ~0 | = | ~0 | 152 SV.K1ToolAct = | TL | 63 |
| | | SV.K1ToolPre: REM Save the | | | | SV.K1ToolPre: REM Save the | | |
| | | date of the tool that was found | | | | date of the tool that was found | | |
| 65 | TL | 155 IF @ACTTOOL01% <> | ~0 | = | ~0 | 155 IF @ACTTOOL01% <> | TL | 65 |
| | | SV.K1ToolPre.Hd.1KQ3 THEN | | | | SV.K1ToolPre.Hd.IKQ3 THEN | | |
| 68 | TL | 165 ENDIF | ~0 | = | ~0 | 165 ENDIF | TL | 68 |
| 70 | TL | 182 SV.K1ToolAct = | ~0 | = | ~0 | 182 SV.K1ToolAct = | TL | 70 |
| | | SV.K1ToolPre: REM Save the | | | | SV.K1ToolPre: REM Save the | | |
| | | date of the tool that was found | | | | date of the tool that was found | | |
| 71 | TL | 183 OLDTOOLNR % = | ~0 | = | ~0 | 183 OLDTOOLNR % = | TL | 71 |
| | | SV.K1ToolAct.Hd.IKQ3: REM | | | | SV.K1ToolAct.Hd.IKQ3: REM | | |
| | | Save the T no. of the tool to be | | | | Save the T no. of the tool to be | | |
| | | replaced | | | | replaced | | |
| 72 | TL | 184 OLDDUPLONR % = | ~0 | = | ~0 | 184 OLDDUPLONR % = | TL | 72 |
| | | SV.K1ToolAct.Hd.IKQ1: REM D | | | | SV.K1ToolAct.Hd.IKQ1: REM D | | |
| | | number of the tool to be replaced | | | | number of the tool to be replaced | | |
| 73 | TL | 185 OLDSEKTOR % = | ~0 | = | ~0 | 185 OLDSEKTOR % = | TL | 73 |
| | | SV.K1ToolAct.Hd.K1: REM | | | | SV.K1ToolAct.Hd.K1: REM | | |
| | | Sector of the tool to be replaced | | | | Sector of the tool to be replaced | | |
| 74 | TL | 186 OLDPLACE % = | ~0 | = | ~0 | 186 OLDPLACE % = | TL | 74 |
| | | SK.K1ToolAct.Hd.K2: REM Save | | | | SK.K1ToolAct.Hd.K2: REM Save | | |
| | | the place of the tool to be | | | | the place of the tool to be | | |
| | | replaced | | | | replaced | | |

In the 3^{rd} and 7^{th} columns, the particular program parts are presented relative to one another such that the contents of two program rows may be compared in one row of the table. The 4^{th} and 6^{th} columns contain times and instants at which these program rows were processed, and the 5^{th} column contains a comparison of these times. This depiction may also be used to very quickly provide the user with information about changes that have already been made to a program. In the section shown in table 1, the particular times are approximately 0 in most of the rows, i.e., the only difference between them may simply be that they do not show any digits to the right of the decimal. A = symbol is therefore also shown in the 5^{th} column. Time-related changes are shown only in the uppermost row, which is also indicated by the > symbol shown in the 5^{th} column.

Furthermore, it is also possible, as shown in FIGS. 7a, b, to provide the user with related oscilloscope and analyzer displays 38 of the individual sequences (in the form of signals and data) of various subsystems and drives, PLC, NC/Motion/RC, PC and the like, in a time-synchronous manner with the actual control program (e.g., in the form of the multiple-channel display) in graphical form. Optionally, a machining simulation is also feasible, via which the user may more quickly obtain the proper perspective in terms of spacial orientation and machining. Via this depiction, any possible delays that occur in the sequences may be analyzed very exactly in terms of their possible causes.

Moreover, an analysis may be carried out such that, in a special depiction, the user is shown the parts that are making the passes, and the frequency of the pass (profiling) via the use of the data that were recorded, and the original NC programs. The times required for the passes may also be indicated. In this manner, the user may quickly recognize sequences that are unreliable. A flow chart of individual program parts may also be displayed for the purpose of performing this analysis.

Furthermore, it is also possible within the scope of the analysis to consider individual program parts in a focussed manner, e.g., in order to analyze various sequences of a program part that is being executed. This procedure is depicted in table 2, below:

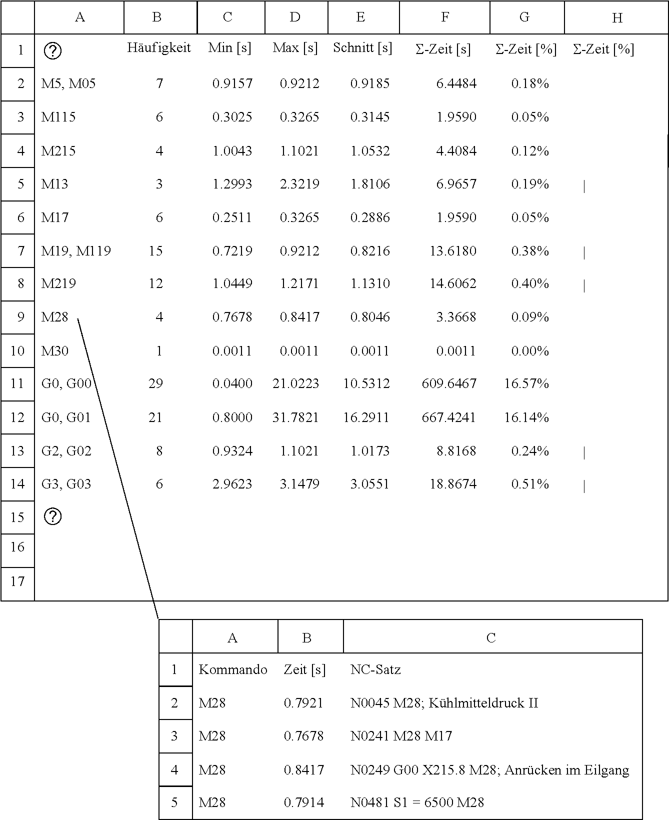

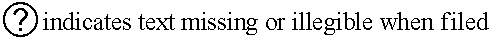

| DE | EN |
|---|---|
| Häufigkeit | Frequency |
| Schnitt | Interval |
| Σ-zeit | Σ time |
| Kommando | Command |
| NC-Satz | NC block |
| Kühlmitteldruck II | Coolant pressure II |
| Anrücken im Eilgang | Approach in rapid motion |

Using a profile display of this type, the user may quickly recognize sequences that are highly time-intensive. In addition to the display of the special program part and the NC CPL block, additional information on the frequency, a frequency expressed as a percent, a minimum time, a maximum time for a pass, a mean time for the pass, a percentage mean time, a sum of the pass times, and a sum of the pass times in seconds or percent, and possible a bar chart. Other types of displays are also possible. Program parts that are particularly time-intensive may be displayed using an appropriate bar chart.

Furthermore, it is also possible to sort individual program parts, e.g., according to the frequency of the minimum time and the maximum time, and the like, in order to thereby identify program parts that are particularly time-intensive. By focussing especially on certain program parts, certain continually recurring subsequences, e.g., a spindle run-up at the start of machining, may be analyzed in a highly exact manner.

Flow charts of the individual program parts may also be output on the basis of the data recorded in the data collection process, and on the basis of the original NC programs. In this manner, the user is provided with a quick overview of available logics and branches, thereby making it possible to quickly identify processes in highly complex applications that are unreliable or unnecessary. Relevant program runs that should be analyzed and optimized in terms of minimizing cycle time may be identified very quickly in this manner. (An optimization of this type may be left out in the secondary branches, e.g., for the error response.)

To ensure clarity, individual aspects of these flow charts may be hidden, such as comments, block comments, CPL blocks with and without conditional/unconditional jumps, or even NC blocks with and without conditional/unconditional jumps. The user may use view filters to create an overview, or in order to more quickly evaluate individual sequences. He may selectively turn individual points on or off. Examples of points of this type are CPL blocks, NC blocks, motions, and/or comments.

It is also possible (see FIGS. 6a, b) to combine a plurality of the above-mentioned displays in one display. For example, the displays shown in FIGS. 6a, b may be output together with the related program parts, while also displaying the particular execution times. In this manner, the user may view several displays at the same time. The collecting device according to the present invention automatically synchronizes displays of this type within one multiple display. It is significant that the same NC programs having the same time stamp are used as the basis in individual displays, in order to create new interrelationships in this manner using the display device. At the same time, sequences that are particularly time-intensive may be identified in this manner.

FIGS. 7a, b show such an example for a double display. The top section contains a depiction of the type shown in FIG. 4, and the lower section contains a list of the particular times for the individual program intervals. It is clear that, e.g., program row N650 is present in both program parts. In the image at the top, it is clear that the motion has been ended prematurely (reference numeral 26), and the block processing (IPO) is waiting for the NC block to advance (reference numeral 28). It is therefore possible to compare the time required to process a certain program row with the time actually required for a motion that was thereby brought about. Reference numeral 26 refers to blocks with motions, and reference numeral 28 refers to the amount of execution time of the blocks that actually remains.

In a further advantageous variant of the method, a search function is provided, using which the user may search for specified passages, e.g., in program parts. Searches may be conducted, e.g., by character, such as block numbers. It is also possible to locate any character or combinations of characters within an NC block. It is also possible to search specifically for times, e.g., using the above-mentioned relation symbols (<, ≦, >, ≧, = . . . ) for a specified value. The specified time may relate to different types of time, such as the interpretation time (CPL), the preparation time (NC), the execution time (IPO), the motion time (IPO), or the program execution time. Time interruptions may also be searched for in the same manner, i.e., via relation symbol and/or types of time. As explained above, time-intensive elements or gaps in block execution or motion execution may be identified specifically in this manner.

By using an expanded viewing filter, the user may specify characters or combinations of characters (strings) that may be displayed or hidden as necessary. It is possible, e.g., to issue the instruction to hide the strings G0, G00, or SCO, or to display the combinations Wait*, M3, M03, M19, M4, M04, and M05.

Furthermore, it is preferable to provide a sort function. Using this sort function, it is possible to sort characters or combinations of characters, such as block numbers or any combinations in the NC block. Within the scope of time detection, it is also possible to sort by relation symbol or types of time, and, within the scope of time interruptions, it is possible to sort by relation symbol or types of time.

By using a global time display, the user may select, within the various displays, the type of time that is relevant to him; again, a distinction may be made between the interpretation time (CPL), the preparation time (NC), the execution time (IPO), the motion time (IPO), or the program execution time. The particular time that is selected may be selected in an incremental and/or absolute manner.

All of the features disclosed in the application documents are claimed as being essential to the present invention, provided they are novel compared to the prior art, either individually or in combination.

### LIST OF REFERENCE NUMERALS

4 Data collection device
6 Block data
7 Data distribution device
8 Signals
I, II, III,
IV, V Steps
A, B Steps
10 Memory unit
12 Memory unit
14 Interchangeable memory unit
14a, 14b, 14c Memory block of the interchangeable memory unit
16 Permanent memory
17 Definition
18 NC program
19 SD control structure
21a, 21b Bar
23 Time interval for interpretation
25 Preparation (for a motion process)
26 Block for motion
28 Block for execution

What is claimed is:

1. A method for the simplification and/or optimization of process sequences for the control of a machine, and, in particular, of a machining tool, in which the machine includes a large number of subsystems, and each individual subsystem of the machine operates using process sequences having cycle conditions that differ at least partially,
wherein
data sets that are characteristic of the cycle conditions of the individual subsystems are collected via a data collection device, and at least two data sets are made available, in an at least partially combined manner, to the user, in particular via a display device.

2. The method as recited in claim 1,
wherein
the at least two data sets are assigned to at least two different subsystems.

3. The method as recited in claim 1,
wherein
the at least two data sets are assigned to different process sequences of the same subsystem.

4. The method as recited in claim 1,
wherein
the cycle conditions are cycle times of the individual subsystems.

5. The method as recited in claim 1,
wherein
data sets of all subsystems are output to the user in a combined manner.

6. The method as recited in claim 1,
wherein
data that are collected by the data collection device are compared to one another using a comparator unit.

7. The method as recited in claim 1,
wherein
time stamps of processes taking place on the individual machines are collected by the data collection device.

8. The method as recited in claim 2,
wherein
a large number of time intervals for different process sections running on the subsystems is defined for each subsystem.

9. The method as recited in claim 8,
wherein
the time intervals are selected from a group of time intervals that includes main times, secondary times, tool change times, work piece change times, measurement times, unloading times, and the like.

10. The method as recited in claim 8,
wherein
the time intervals of different subsystems are compared to one another.

11. The method as recited in claim 1,
wherein
process times of parts of process sequences are determined from the data sets, and information is output to the user on the basis of these process times.

12. The method as recited in claim 1,
wherein
the collected data sets are made available via the Internet.

13. The method as recited in claim 1,
wherein
the data or data sets to be collected are measured at least partially on a control device.

14. A device for the simplification and/or optimization of process sequences for the control of a machine, and, in particular, of a machining tool, in which the machine includes a large number of subsystems, and each individual subsystem of the machine operates using process sequences having cycle conditions that differ at least partially,
wherein
the device includes a data collection device that collects data sets that are characteristic of the cycle conditions of the individual subsystems, and at least one display device that outputs at least two data sets in an at least partially combined manner.

15. The device as recited in claim 12,
wherein
the device includes a comparator unit that compares at least two data sets to one another and outputs a signal that is characteristic of this comparison.
